(19) United States
(12) Patent Application Publication
(10) Pub. No.: US 2007/0275816 A1
(43) Pub. Date: Nov. 29, 2007

(54) Noise reduction in epicyclic gear systems

(75) Inventor: Geoffrey Morgan Henderson, Christchurch (NZ)

Correspondence Address: DENNISON, SCHULTZ & MACDONALD, 1727 KING STREET, SUITE 105, ALEXANDRIA, VA, 22314, US

(73) Assignee: Windflow Technology Ltd.

(21) Appl. No.: 11/806,077

(22) Filed: May 29, 2007

Related U.S. Application Data
(60) Provisional application No. 60/808,578, filed on May 26, 2006.

(51) Int. Cl. F16H 57/08

(52) U.S. Cl. 475/331

(57) ABSTRACT

An epicyclic gear system having a sun gear, a ring gear and P planet gears. The planet gears include a load equalisation system such as a flexible spindle. The gears are structured according to a K factor which depends on the number of planet gears and the number of teeth on the sun gear. A gear system of this kind can be relatively quiet and cost effective, and suitable for use in a wind turbine.

### BACKGROUND TO THE INVENTION

This invention relates to epicyclic or planetary gear systems, in particular but not only to a system for use in reducing noise from wind turbines.

Wind turbines are increasingly used to capture and convert wind energy into electricity. Recent improvements in the design of these turbines have lowered their cost to the point where they are now commercially viable as alternatives to other sources of power. However, where the turbines are located near populated areas, the noise that they also generate is often a sensitive planning issue.

Noise problems usually arise due to gearbox vibration. Wind turbines normally use epicyclic gearboxes and these may be more or less noisy depending on a number of factors, such as the choice of straight-cut versus helical gears, the quality of the gears (accuracy and surface finish), the precision of the overall gearbox design (concentricity of bearing housings etc), and detailed modifications to the involute gear shape (tip and root relief). The design of the casing that surrounds the gearbox and other parts of the turbine also plays an important role, and heavier casings will normally be quieter. Rubber mounting of the gearbox can be useful in some cases. Avoiding resonances in the drive-train or in the casing and its mounting to the supporting structure, is also important.

The prior art generally suggests that a quiet epicyclic gearbox for a wind turbine would have: helical gears, a high quality surface finish, high precision in the overall gearbox design and manufacturing, tip and root relief optimized to minimize vibration at critical loadings (typically 40% of rated for a wind turbine because of the beneficial masking effect of wind noise at higher loadings), a heavy casing, be rubber mounted, and avoid any resonances. However, all of these options except possibly the last, generally add cost to the gearbox and therefore also reduce the commercial viability of the turbine.

One approach for reducing vibration and noise in epicyclic systems is “planet phasing”. The planet configuration and tooth numbers are chosen so that the net forces and torques on the sun and ring gears, and on the carrier of the planet gears, are reduced by self equilibration.

Previous attempts to implement phasing have produced reductions in vibration and noise for helicopters and other engines, but due to imperfections in the gear systems the results were not sufficiently quiet to be helpful for wind turbines.

A theoretical analysis of planet phasing in epicyclic spur systems was given several years ago by Robert Parker, in his paper “A physical explanation for the effectiveness of planet phasing to suppress planetary gear vibration”, Journal of Sound and Vibration (2000) 236(4), 561-573. However, the paper assumes an idealised system with equal load sharing among at least four planets.

It is known that a conventional epicyclic system with three planet gears is the only system for which equal load-sharing can be assumed. Standard design factors are required to reflect the inequal load-sharing for four and higher numbers of planets, to the point where there is generally no economic benefit in exceeding four planets with conventional epicyclic designs. Thus it is not possible to realise the full benefits of the Parker analysis in conventional epicyclic gearing.

Variations to the basic design of epicyclic spur gears were also created by Raymond Hicks as described in U.S. Pat. No. 3,303,713 (1967) and U.S. Pat. No. 4,700,583 (1987) for example. His design involved a flexible spindle for the planet gears which reduces the need and cost of highly accurate machining in some parts of the gearbox. It can also enable more compact designs. The spindle allows the load to equalise between the planet gears despite the inaccuracies that may exist.

However, the Hicks design was not intended to be particularly quiet and in practice it is generally as noisy as other designs. It has also not been helpful for reduction of the noise problem in wind turbines to date.

### SUMMARY OF THE INVENTION

It is an object of the invention to provide a further improved epicyclic gearbox system for wind turbines in which the benefits of both a quiet and cost effective arrangement of the planet gears can be achieved.

Accordingly in one aspect the invention resides in a epicyclic gear system, including: a sun gear, a ring gear and P planet gears, all contained by a casing, wherein the planet gears include load equalisation means, and wherein P>3 and 1<K₁ (as defined below) <P−1.

Preferably the load equalisation means includes a flexible spindle, and more preferably a compound cantilevered spindle, for each of the planet gears.

In preferred embodiments, P=4 and K₁=2; P=6 and K₁=2, 3 or 4; or P=8 and K₁=2, 4 or 6.

### BRIEF LIST OF FIGURES

Preferred embodiments of the invention will be described with respect to the accompanying drawings, of which:

FIGS. 1a to 1d show end views of a range of epicyclic gear systems,

FIG. 2 is a cross sectional view through an eight planet system with load equalisation,

FIG. 3 is a detailed cross-sectional view through one of the planet gears in FIG. 2, and

FIG. 4 shows operation of the flexible spindle in FIG. 3.

### DESCRIPTION OF PREFERRED EMBODIMENTS

Referring to these drawings it will be appreciated that the invention can be implemented in various forms and for a wide range of gearbox systems such as found in wind turbines. These embodiments are relatively simple and given by way of example only.

The phasing approach to construction of an epicyclic gear system involves use of the following formula to determine the K-factor:

K=modulus[hNₛ/P]

where: h is the number of the harmonic of gear mesh frequency potentially being excited (1^{st}, 2^{nd}, 3^{rd} etc), Nₛ is the number of teeth on the sun gear, P is the number of planets.

The modulus operation determines the integer remainder when the division operation in the square brackets takes place. Thus the K-factor has values 0, 1, 2 . . . (P−1). K₁ can further be defined as the K-factor for the 1^{st} harmonic (h=1).

The following table sets out which of three types of vibration can be generated in a perfect epicyclic gear stage with equi-spaced planets, preferably straight cut or helical spur gears.

| K-factor | Vibration possible |
|---|---|
| 0 | Rotational, not translational |
| 1 or (P-1) | Translational, not rotational |
| Neither 0 nor 1 nor (P-1) | Neither rotational nor translational (but |
| | planet mode possible) |

In order to minimise vibration which can be propagated from the gearcase or through the drive-train as sound, ie to have the quietest gearbox, this last case is generally most desirable.

Consideration of this table and the definition of the K-factor leads to the following conclusions (among others):
a) in order to have neither rotational nor translational forcing in the 1^{st} harmonic (fundamental gear mesh frequency), an epicyclic stage needs at least four planets, ie with three planets it is not possible to have neither forcing
b) in order to have neither forcing in the 1^{st} harmonic and no translational forcing in the higher harmonics, an epicyclic stage needs an even number of equi-spaced planets and a value of K₁ which is not zero, 1 or (P−1) and car, not (when multiplied by any integer value, n) give Kₙ=1 or (P−1), ie K₁=2 for four planets, K₁=2, 3 or 4 for six planets or K₁=2, 4 or 6 for eight planets. Eliminating translational forcing is beneficial in wind turbines because the turbine rotor is sensitive to translational vibration of the main shaft and will transmit such vibration to the environment as sound emissions.
c) For the above benefits to be realised in practice, the gearing needs to behave as if it were perfect gearing, meaning that it has to achieve equal load sharing among the planets. The analysis relies on equal load sharing, in order that the vector addition of the tooth forces results in cancellation of rotational and/or translational terms respectively.

In general the following range of epicyclic gear parameters are expected to result in low-noise operation so long as load sharing can be provided;

| | Low noise with following | Particularly low noise with |
|---|---|---|
| No. of planets | values of K₁ | following values of K₁ |
| 4 | 2 | 2 |
| 5 | 2, 3 | |
| 6 | 2, 3, 4 | 2, 3, 4 |
| 7 | 2, 3, 4, 5 | |
| 8 | 2, 3, 4, 5, 6 | 2, 4, 6 |

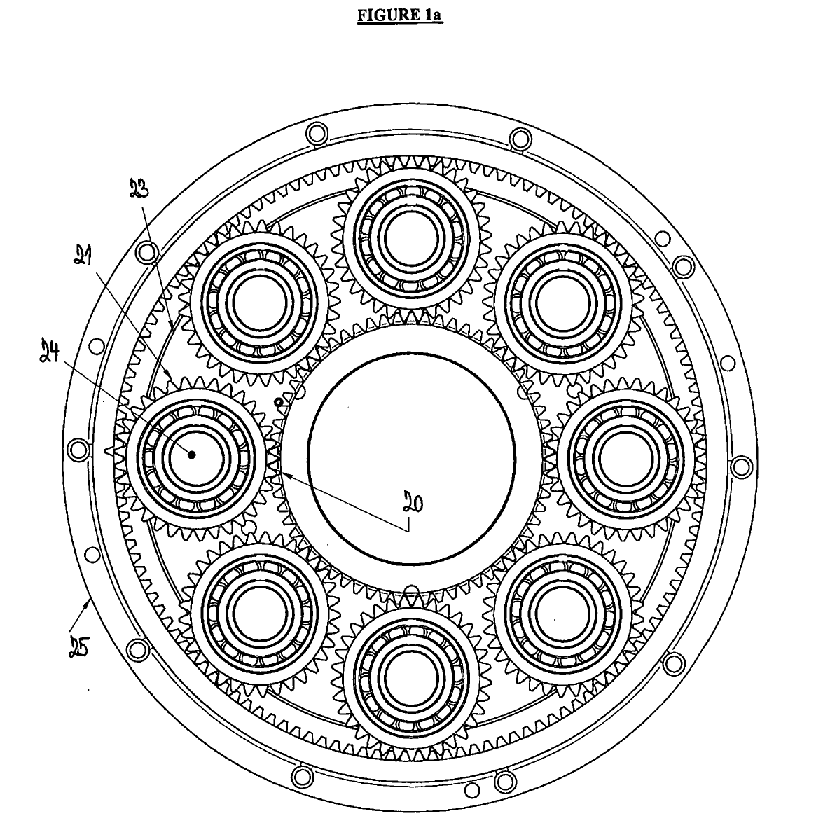

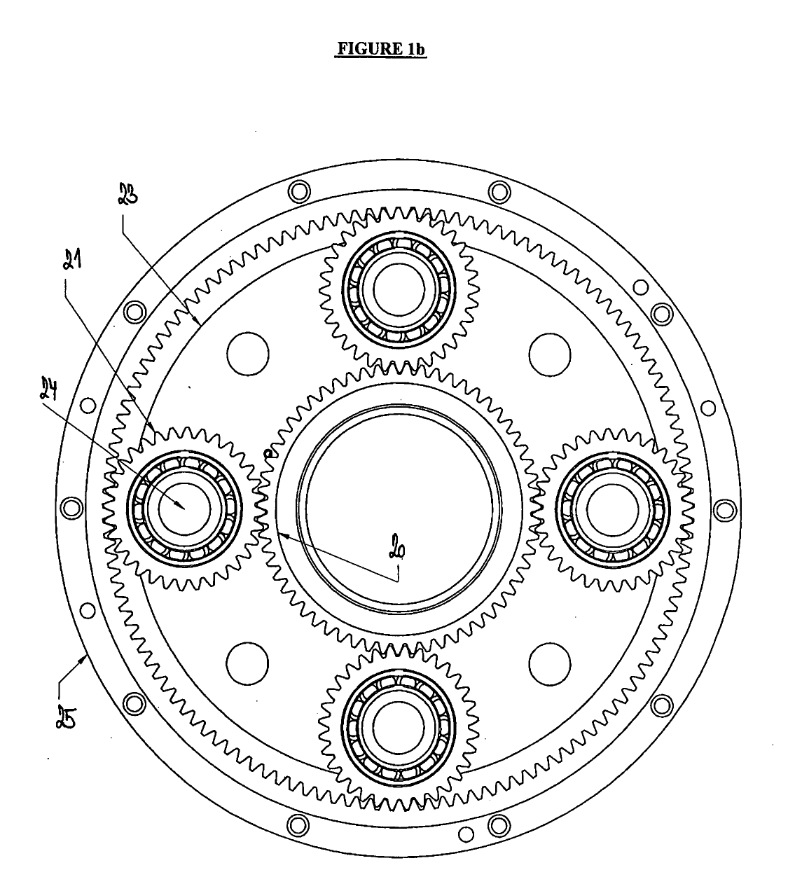

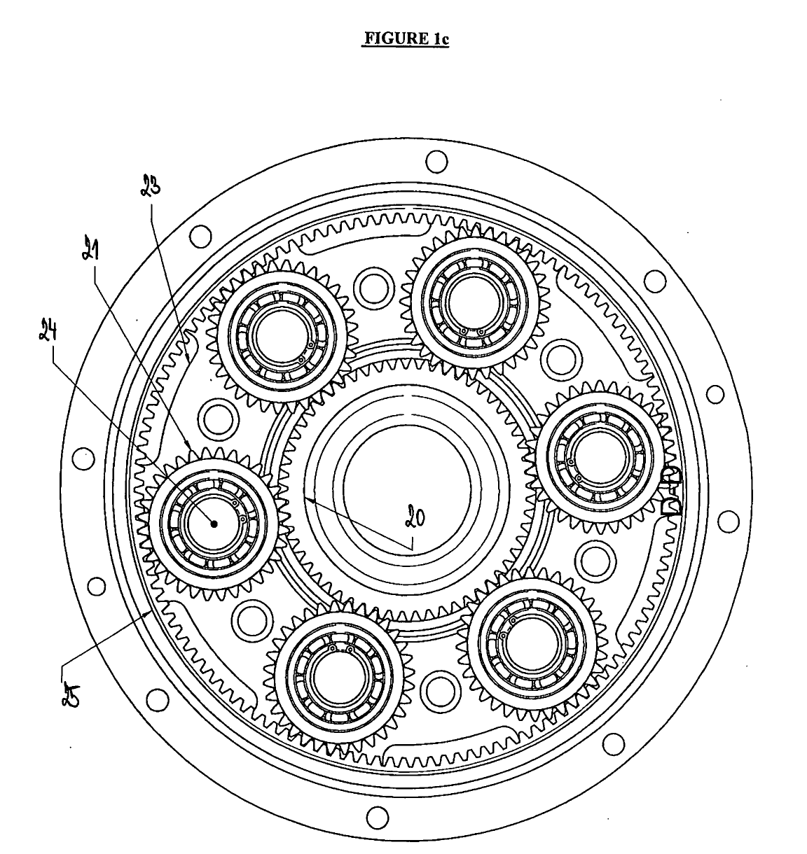

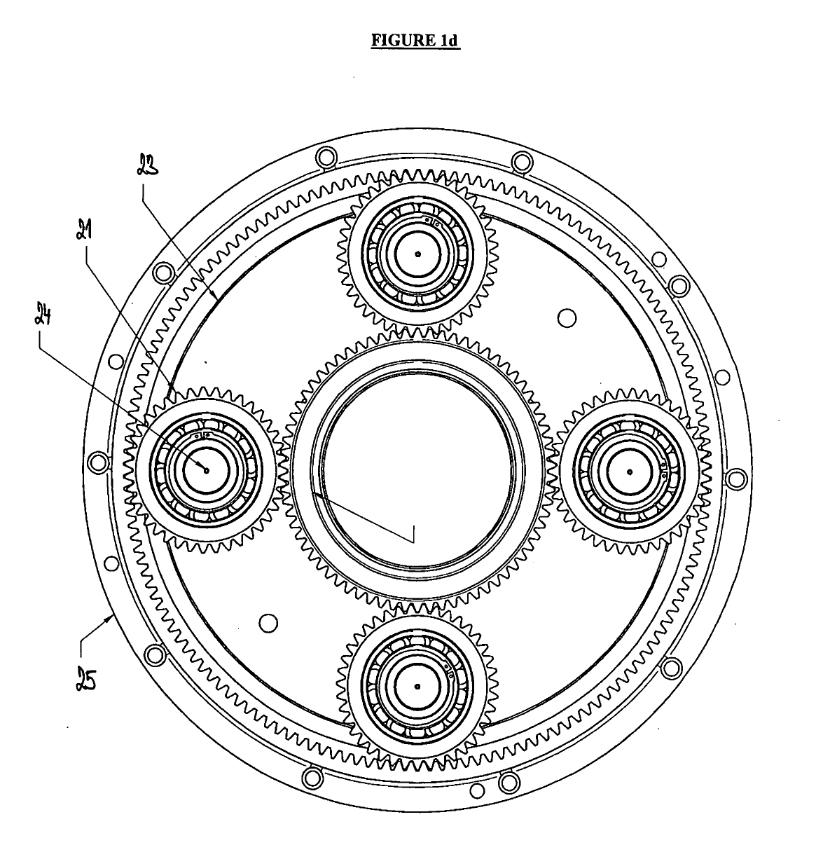

FIGS. 1a-1d show a range of epicyclic gear systems which have demonstrated the noise reduction possibilities of the invention, FIGS. 1a-1c show three epicyclic gear stages of a complex gearbox with preferred values for P and K. Specifically these are P=8 and K₁=2, 4 or 6 in FIG. 1a; P=4 and K₁=2 in FIG. 1b; P=6 and K₁=2, 3 or 4 in FIG. 1c. In contrast, FIG. 1d shows an epicyclic system with non-preferred values of P and K. Specifically these were P=4 and K₁=3. This configuration resulted in significant translational excitation of the gearing at the 1^{st} harmonic which resulted in a noise problem due to vibration of connected components, including the wind turbine blades themselves (any acoustic vibration of the wind turbine blades can cause an environmental noise problem because the blades will propagate the sound to neighboring residents).

The following table sets out these values for FIGS. 1a-1d along with K-values at higher harmonics, and the type of vibration which it will excite (translational, rotational or neither).

| | | Harmonic (h) | Kh | Excitation |
|---|---|---|---|---|
| FIG. 1a - 1st Stage | | 1 | 6 | Neither |
| No. of Planets (P) | 8 | 2 | 4 | Neither |
| No. of sun teeth (Ns) | 62 | 3 | 2 | Neither |
| | | 4 | 0 | Rotational |
| | | 5 | 6 | Neither |
| | | 6 | 4 | Neither |
| FIG. 1b - 2nd Stage | | 1 | 2 | Neither |
| No. of Planets (P) | 4 | 2 | 0 | Rotational |
| No. of sun teeth (Ns) | 70 | 3 | 2 | Neither |
| | | 4 | 0 | Rotational |
| | | 5 | 2 | Neither |
| | | 6 | 0 | Rotational |
| FIG. 1c - 4th Stage | | 1 | 3 | Neither |
| No. of Planets (P) | 6 | 2 | 0 | Rotational |
| No. of sun teeth (Ns) | 57 | 3 | 3 | Neither |
| | | 4 | 0 | Rotational |
| | | 5 | 3 | Neither |
| | | 6 | 0 | Rotational |
| FIG. 1d - non-preferred Stage | | 1 | 3 | Translational |
| No. of Planets (P) | 4 | 2 | 2 | Neither |
| No. of sun teeth (Ns) | 59 | 3 | 1 | Translational |
| | | 4 | 0 | Rotational |
| | | 5 | 3 | Translational |
| | | 6 | 2 | Neither |

Conventional wisdom says that a three-planet epicyclic system is the only one for which equal load-sharing can be assumed. Standard design factors need to be used to reflect the unequal load-sharing for four and higher numbers of planets, to the point where there is generally no economic benefit in exceeding four planets with conventional epicyclic designs. Thus it is not possible to realise the full benefits of the analysis for conventional epicyclic gearing. As stated in conclusion a) above, with three planets it is not possible to have neither forcing. With higher numbers of planets, the theoretical possibility of having neither forcing in the 1^{st} harmonic is compromised in practice by the unequal load-sharing.

Incorporating flexible spindles is one way to enable load-sharing among the planet gears. A flexible spindle typically involves the use of a compound cantilever so that the planet teeth remain parallel along the gear-mesh even as the spindle flexes. Tie spindle itself is sufficiently flexible that, under design loadings, its deflection is an order of magnitude greater than the possible cumulative machining errors which would otherwise cause unequal loading. In the gear system of a wind turbine, a typical deflection might be around 0.5 mm for example, whereas cumulative machining errors would be 0.05-0.10 mm. To a first-order approximation, which in engineering design terms usually means within 1 or 2%, the flexible spindle concept achieves perfect load sharing. Low noise gear systems such as those suggested above can therefore be achieved in practice.

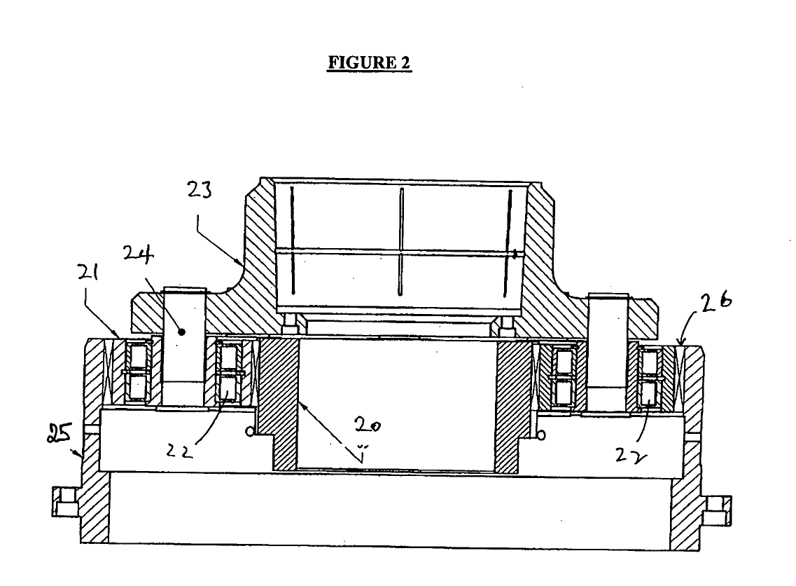

FIGS. 1a and 2 are end and cross sectional views showing the main components of an epicyclic gear system. In this example the system includes a central or sun gear 20 surrounded by eight planet gears 21 mounted on respective bearings 22. Only two of the planet gears can be seen in FIG. 2. A planet carrier 23 supports the planet gears through respective pins or spindles 24 and bobbins. An annulus gear or casing 25 surrounds the planet gears. The planet gears engage the sun gear and the annulus gear through gearmeshes 26. One way to enable load sharing in this system is to provide flexible spindles for each or at least some of the planet gears. A range of spindle designs are possible. FIGS. 1b, 1c, 1d show epicyclic systems for comparison with FIG. 1a and which can be considered in relation to details given in the table above.

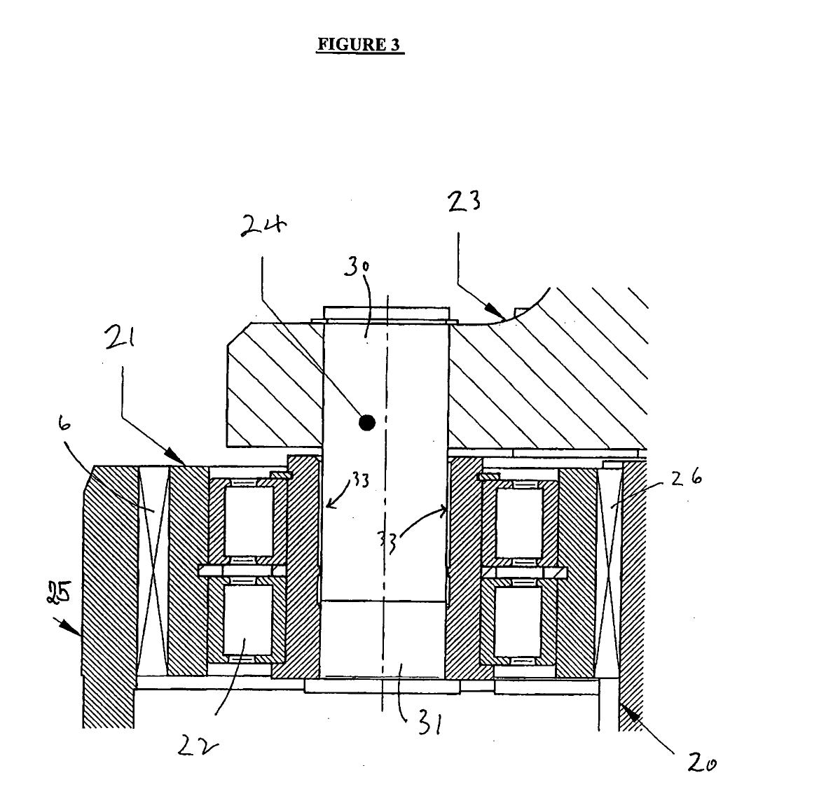

FIG. 3 is a cross section showing one of the planet gears 21 in more detail, in an unloaded condition. In this example the spindle 24 is made flexible by way of a compound cantilevered arrangement. One end 30 of the spindle is fixed to the planet carrier 23 while the other end 31 is fixed to the planet gear. The center region of the spindle is spaced from the center of the planet gear by a clearance region 33 having a width sufficient for the loading which is expected in normal use.

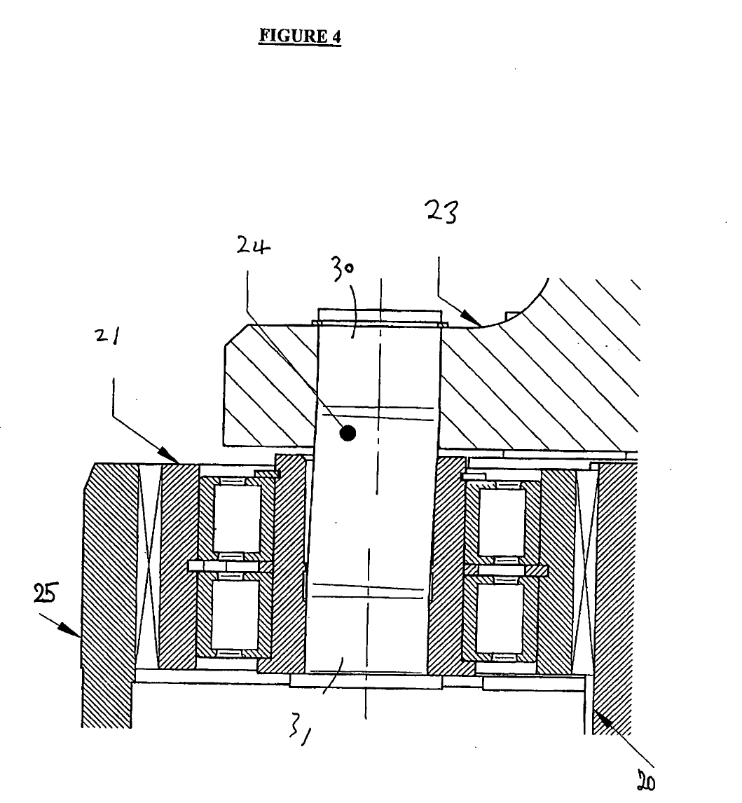

FIG. 4 shows how the planet gear in FIG. 3 behaves under load, When the gearmesh 26 imposes tangential and radial loads on the gear, the load is transmitted through the bearings 22 to a cantilevered bobbin. This imposes a bending deflection on the spindle within the clearance space 33. The spindle has much lower bending stiffness than the bobbin. Since the spindle in turn is cantilevered from end 31, there are two angular deflections of opposite sense imposed on the spindle. By suitably arranging the geometry of the fits with respect to the center of gearmesh loading on the pinion, it is possible to ensure that the two angular deflections cancel each other out, so that the gearmesh stays parallel, or more precisely so that loading along the length of the gearmesh remains uniform.

Furthermore it is possible, without compromising the fatigue strength of the spindle, to ensure that the spindle deflections under maximum design loadings are an order of magnitude higher than the cumulative machining errors. This ensures uniform load sharing between the planets, regardless of the number of planets, while introducing no concerns about fatigue strength of the spindle.

1. An epicyclic gear system, including: a sun gear, a ring gear and P planet gears, all contained by a casing, wherein the planet gears include load equalisation means, and wherein P and K (as defined herein) satisfy the relations P>3 and 1<K₁<P−1.

2. A gear system as in claim 1 wherein the load equalisation means includes a flexible spindle for each of the planet gears.

3. A gear system as in claim 1 wherein the load equalisation means includes a compound cantilevered spindle for each of the planet gears.

4. A gear system as in claim 1 wherein P=4 and K₁=2; P=6 and K₁=2, 3 or 4; or P=8 and K₁=2, 4 or 6.

5. A gear system as in claim 4 which uses straight-cut spur gears.

6. A gear system substantially as herein described with reference to the drawings.
